(19) United States
(12) Patent Application Publication
(10) Pub. No.: US 2003/0021021 A1
(43) Pub. Date: Jan. 30, 2003

(54) Microscope glass slide for cytology PAP smears

(76) Inventor: Vellie Branch, Fort Washington, MD (US)

Correspondence Address: Richard C. Litman, LITMAN LAW OFFICES, LTD., P.O. Box 15035, Arlington, VA, 22215, US

(21) Appl. No.: 10/178,851

(22) Filed: Jun. 25, 2002

Related U.S. Application Data
(60) Provisional application No. 60/307,611, filed on Jul. 26, 2001.

(51) Int. Cl. G02B 21/34; G01N 21/01

(52) U.S. Cl. 359/396; 359/397; 359/398

(57) ABSTRACT

A transparent elongated, rectangular glass microscope slide having a specimen observation spot defined by a removable border or frame. The border corresponds to the rectangular perimeter of the glass slide and includes a tab which may be grasped to peel off the border. In use, a cytological GYN PAP smear specimen is placed on the plain glass within the confines of the releasable paper border. The border is then removed after fixing the specimen. The slide also features a frosted end portion for marking identification data. The frosting may include permanent markings such as “NAME” to designate a certain frosted area for marking the desired information such as the patient's name and identification number. A tab is placed on the border end and overlaps a portion of the frosted area, and thus does not protrude outward from the side of the slide.

### CROSS-REFERENCE TO RELATED APPLICATION

This application claims the benefit of U.S. Provisional Patent Application Serial No. 60/307,611, filed Jul. 26, 2001.

### BACKGROUND OF THE INVENTION

1. Field of the Invention

The present invention relates to microscope slides. More particularly, the invention relates to a slide having a specimen observation spot defined by a removable paper border and a frosted identification portion.

2. Description of Related Art

Microscope slides are widely used in the health industry. Their use in PAP smear procedures is well known. In conventional slides during analysis or manipulation of the slide the sample or treatment fluid may run off or migrate onto other portions of the slide, “wick off” if the slide touches another object, or suffer cross contamination between slides. It would by desirable to provide a conveniently used slide which avoids these problems.

U.S. Pat. No. 5,948,685, issued Sep. 7, 1999 to Angros describes an analytic plate with a containment border for preventing the migration of fluid specimen disposed thereon. The border is substantially flush with the surface of the slide and may be removable. A frosted portion is provided which allows identification marks to be placed thereon.

U.S. Pat. No. 5,784,193, issued Jul. 21, 1998, to Ferguson describes a microscope slide having one or more removable frames for defining a centrally disposed area for depositing a specimen for observation. The frames are provided with tabs along the side of the slide for easy removal of the frames.

U.S. Pat. No. 5,571,721, issued Nov. 5, 1996, to Turner, describes a culture slide kit having elongated glass slides with frosted end portion for marking and providing a compartmented frame.

U.S. Pat. No. 4,190,314, issued Feb. 26, 1980 to Goldsmith describes a PAP smear microscope slide having a transparent cover for placing over the sample.

None of the above inventions and patents, taken either singly or in combination, is seen to describe the instant invention as claimed.

### SUMMARY OF THE INVENTION

The present invention is a transparent elongated, rectangular glass microscope slide having a specimen observation spot defined by a removable border or frame. The border corresponds to the rectangular perimeter of the glass slide and includes a tab which may be grasped to peel off the border. In use, a cytological GYN PAP smear specimen is placed on the plain glass within the confines of the adhesive releasable paper border. The border is then removed after fixing the specimen. The slide also features a frosted end portion for marking identification data. The frosting may include permanent markings such as “NAME” to designate a certain frosted area for marking the desired information such as the patient's name. A non-adhesive tab is placed on the border end and overlaps a portion of the frosted area, and thus does not protrude outward from the side of the slide.

Accordingly, it is a principal object of the invention to provide a microscope slide having an easily removable frame or border for retaining the specimen within a desired portion of the slide.

It is another object of the invention to provide a slide having a frame or border as above and a frosted end portion for identification.

It is a further object of the invention to provide a slide as above wherein the frame or border is made easily removable by the provision of a pull tab.

Still another object of the invention is to provide a slide as above wherein the tab is located over the frosted end portion so as to avoid any protrusion outside the edges of the frame.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a microscope glass slide for cytology PAP smears according to the present invention.

FIG. 2 is a plan view of the microscope glass slide of FIG. 1.

FIG. 3 is a side view in elevation of the microscope glass slide of FIG. 1.

Similar reference characters denote corresponding features consistently throughout the attached drawings.

### DETAILED DESCRIPTION OF THE PREFERRED EMBODIMENT

The present invention is a transparent elongated, rectangular glass microscope slide having a specimen observation spot defined by a removable border or frame. The border corresponds to the rectangular perimeter of the glass slide and includes a tab which may be grasped to peel off the border. In use, a cytological PAP smear specimen is placed on the plain glass within the confines of the adhesive releasable paper border. The border is then removed before staining the slide. The slide also features a frosted end portion for marking identification data. The frosted end may include permanent markings such as “NAME” to designate a certain frosted area for marking the desired information such as the patient's name and identification number. A non-adhesive tab is placed on the border end and overlaps a portion of the frosted area, and thus does not protrude outward from the side of the slide.

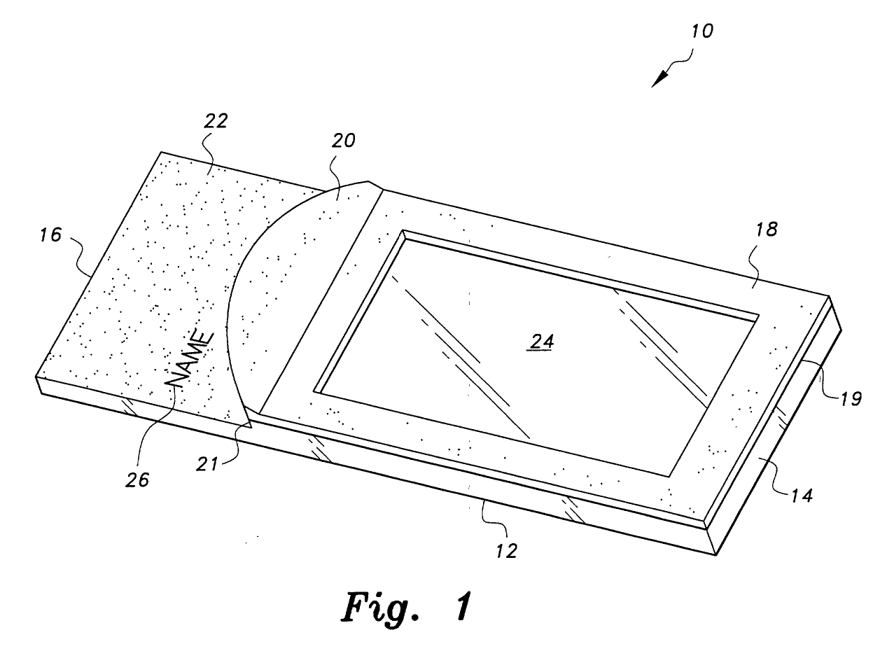

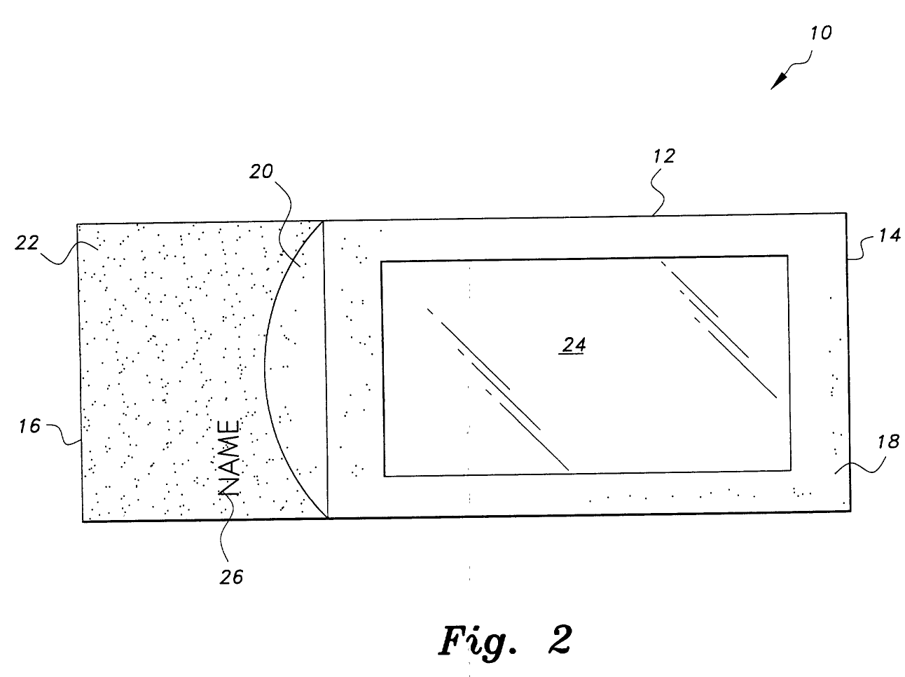

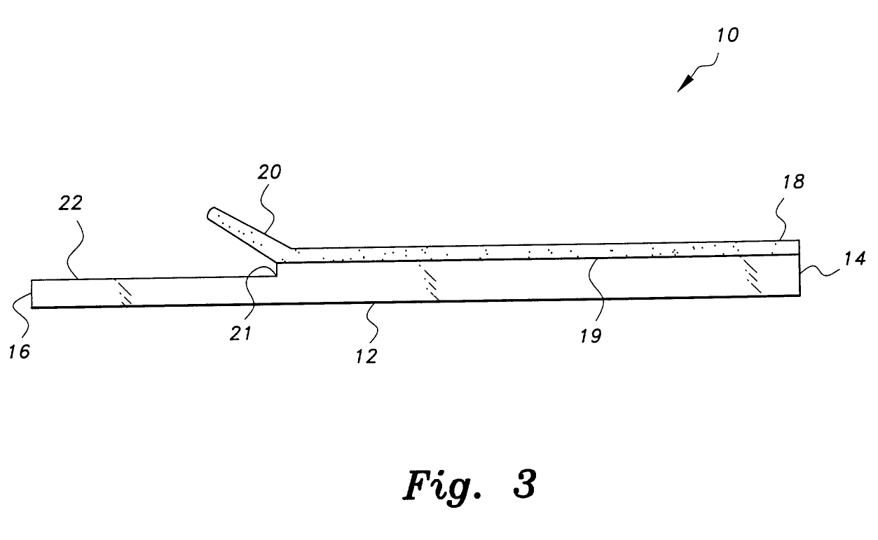

Referring to FIGS. 1-3 there is shown a perspective view, a plan view, and a side elevational view, respectively, of the framed slide 10 having glass slide 12 with sample end 14 and label end 16. Glass slide 12 has a sample receiving portion which features removable frame 18 extending between sample outer end 14 ending at tab 20. Frosted glass label area portion 22 extends between label area outer end 16 and label area inner end 21, thus defining an upper surface. Preferably tab 20 angles upward from glass slide 12 at label inner end 21 and is spaced from the upper surface of frosted glass label area portion 22 to expedite grasping of the tab 20. Frame 18 is attached to glass slide 12 by adhesive layer 19, and defines sample receiving surface 24 of the sample receiving portion. Frosted glass label area portion 22 features lettering 26 designating an area for writing certain information such as the patient's name and identification number.

The overall length and width of glass slide 12 are preferably about 7.5 cm. and about 2 cm., respectively. The length of the frosted label area 22 is about 2 cm. in length, making it approximately square. The outer length of the frame 18 is preferably about 5.5 cm. and its outer width about 2 cm. The sides of the frame 18 are about 0.3 cm. in width and the ends of the frame 18 are about 0.5 cm. The thickness of the glass slide 12 is that of a standard microscope slide once the frame 18 is removed by pulling tab 20. The frame 18 may be made of paper or other suitable material of suitable thickness and the adhesive layer 19 comprises a type of adhesive which, when applied in a suitable thickness, allows easy peeling of the frame 18 from the glass slide 12.

Any suitable glass material may be used to form the slide of the present invention. A cover glass of the same surface dimensions as the outer dimensions of the border or frame is placed over the sample once the slide has been stained. Such covers are known in the art of microscope slides for PAP smear samples, such as that taught by U.S. Pat. No. 4,190,314 to Goldsmith, discussed above.

It is to be understood that the present invention is not limited to the sole embodiment described above, but encompasses any and all embodiments within the scope of the following claims.

I claim:

1. A microscope slide having a sample frame or border comprising:
a) a glass slide body having a sample receiving portion and a frosted label area portion;
b) a frame removably adhered to said sample receiving portion and defining a sample receiving surface.
c) said frame having a tab extending toward said frosted label area portion, the tab being for peeling said frame from said sample receiving portion while leaving said sample on said sample receiving surface.

2. The microscope slide of claim 1, wherein said microscopic slide body is in the form of an elongated rectangle, said frosted label area portion forming a square, and the remainder of said slide body forming said sample receiving portion.

3. The microscope slide of claim 1, wherein said frosted label area portion further comprises indicia identifying an area for the placement of identification information.

4. The microscope slide of claim 1, wherein said border is an adhesive releasable paper border.

5. The microscope slide of claim 1, wherein said tab overlaps a portion of said frosted area portion.

6. The microscope slide of claim 5, said frosted area portion having an upper surface and wherein said tab is spaced from said frosted area portion upper surface.

7. The microscope slide of claim 1, wherein said glass slide is about 7.5 cm. in length and about 2 cm., in width.

8. The microscope slide of claim 7, wherein said frosted label area is about 2 cm. in length and said sample receiving area is about 5.5 cm. in length.

9. The microscope slide of claim 8, wherein said frame has a side width of about 0.3 cm. and an end width of about 0.5 cm.

10. The microscope slide of claim 9, wherein said slide is that of a standard microscope slide plus the thickness of said adhered frame.
